(19) United States
(12) Patent Application Publication
(10) Pub. No.: US 2016/0308462 A1
(43) Pub. Date: Oct. 20, 2016

(54) DRIVING MODULE AND DRIVING METHOD

(71) Applicant: Mediatek Inc., Hsin-Chu (TW)

(72) Inventor: Chun-Chih Hou, Tainan City (TW)

(21) Appl. No.: 14/685,608

(22) Filed: Apr. 14, 2015

(51) Int. Cl. H02M 7/537

(52) U.S. Cl. CPC H02M 7/537

(57) ABSTRACT

A driving module comprising a transformer and at least one driver. The transformer comprises: a primary side, comprising a first input terminal, a second input terminal, and a center terminal coupled to a first predetermined voltage, wherein the primary side is center tapped at the center terminal; a secondary side. The driver is coupled to a second predetermined voltage, configured to receive at least one input signal, to provide a first input current flowing from the first input terminal to the center terminal, and to provide a second input current flowing from the second input terminal to the center terminal. The primary side generates an input voltage based on the first input current and the second input current, wherein the secondary side generates an output voltage based on the input voltage. The second predetermined voltage is higher than the first predetermined voltage.

### BACKGROUND

The present application relates to a driving module and a driving method, and particularly relates to a driving module and a driving method which has a low noise, a higher reliability and can meet different requirements.

Conventionally, a driving module is applied to provide a desired driving voltage. FIG. 1 is a circuit diagram illustrating a related art driving module 100. As illustrated in FIG. 1, the driving module 100 comprises a transformer 101 and drivers D_1, D_2. The transformer 101 comprises a primary side S_p and a secondary side S_s. The primary side S_p comprises input terminals T_in1, T_in2, and a center terminal T_c. The primary side S_p is center tapped at the center terminal T_c, and the center terminal T_c is coupled to a supply voltage Vcc.

The drivers D_1, D_2 are coupled to a ground voltage, which is lower than the supply voltage Vcc. Also, the drivers D_1, D_2 sink currents I_1, I_2 from the center terminal T_c. By this way, an input voltage V_in can be generated via the primary side S_p based on the currents I_1, I_2. Then the secondary side S_s generates an output voltage V_out based on the input voltage V_in. A ratio of “input voltage V_in to output voltage V_out” depends on a ratio of “coil amount of the primary side S_p to coil amount of the secondary side S_s”. Other details for the operations of the primary side S_p and the secondary side S_s are well known by persons skilled in the art, thus are omitted for brevity here.

The secondary side S_s comprises output terminals T_o1, T_o2, which can be coupled to any electronic apparatus, to provide the output voltage V_out to the electronic apparatus.

However, such structure has some defects. For example, if the driving module 100 is applied to electronic apparatuses following different operating modes but the supply voltage Vcc is fixed, the power is wasted if the electronic apparatus needs a signal amplitude (i.e. the output voltage V_out) lower than the Vcc, and the electronic apparatus may not smoothly operate if the electronic apparatus needs a signal amplitude higher than Vcc.

An electronic apparatus needs different operating modes because it may follow different standards, drive different length cable, or other possible reasons. Additionally, since the center terminal is coupled to the supply voltage Vcc, the noise from a source providing the supply voltage Vcc may affect the input voltage V_in, thus affects the output voltage V_out. Further, in the structure of FIG. 1, the drivers D_1 and D_2 apply NMOSFETs to sink currents I_1, I_2. However, an NMOSFET have a low reliability, thus causes the low reliability of drivers D_1, D_2.

Therefore, a new driving module and a new driving method are needed to solve above-mentioned issues.

### SUMMARY

One objective of the present application is to provide a driving module, which can reduce noise, can increase reliability and can generate output voltages for different requirements.

Another objective of the present application is to provide a driving method, which can reduce noise, can increase reliability and can generate output voltages for different requirements.

One embodiment of the present application provides a driving module, which comprises: a transformer and at least one driver. The transformer comprises: a primary side, comprising a first input terminal, a second input terminal, and a center terminal coupled to a first predetermined voltage, wherein the primary side is center tapped at the center terminal; a secondary side. The driver is coupled to a second predetermined voltage, configured to receive at least one input signal, to provide a first input current flowing from the first input terminal to the center terminal, and to provide a second input current flowing from the second input terminal to the center terminal. The primary side generates an input voltage based on the first input current and the second input current, wherein the secondary side generates an output voltage based on the input voltage. The second predetermined voltage is higher than the first predetermined voltage.

Another embodiment of the present application provides a driving method, which is applied to a driving module comprising a transformer with a primary side and a secondary side. The primary side comprises a first input terminal, a second input terminal, and a center terminal coupled to a first predetermined voltage. The primary side is center tapped at the center terminal. The driving method comprises: providing a first input current flowing from the first input terminal to the center terminal based on a second predetermined voltage; providing a second input current flowing from the second input terminal to the center terminal based on the second predetermined voltage, wherein the second predetermined voltage is higher than the first predetermined voltage; applying the primary side to generate an input voltage based on the first input current and the second input current; and applying the secondary side to generate an output voltage based on the input voltage.

Another embodiment of the present application provides a transformer, which comprises: a primary side, comprising a first input terminal configured to receive a first input current, a second input terminal configured to receive a second input current, and a center terminal coupled to a first predetermined voltage; wherein the first input current and the second input current are generated according to a second predetermined voltage higher than the first predetermined voltage; wherein the primary side is center tapped at the center terminal.

In view of above-mentioned embodiments, the driving module and the driving method provided by the present application can reduce noise since the primary side is not coupled to a supply voltage, and can increase reliability since the driver can apply PMOS or PFETs. Additionally, the driving module and the driving method provided by the present application can generate output voltages for different requirements, since the second predetermined voltage can be adjusted.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram illustrating a related art transforming circuit.

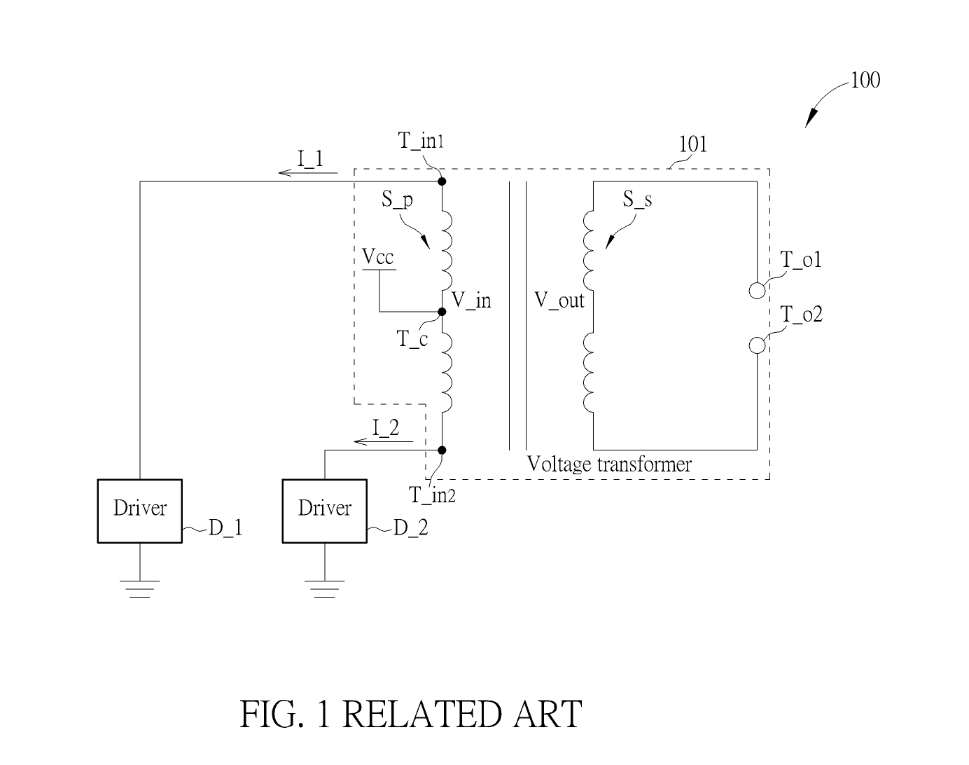

FIG. 2 is a circuit diagram illustrating a driving module according to one embodiment of the present invention.

FIG. 3 is a circuit diagram illustrating an exemplary structure for the driving module depicted in FIG. 2.

FIG. 4 is a circuit diagram illustrating a driving module according to another embodiment of the present invention.

FIG. 5 is a flow chart illustrating a driving method according to one embodiment of the present application.

### DETAILED DESCRIPTION

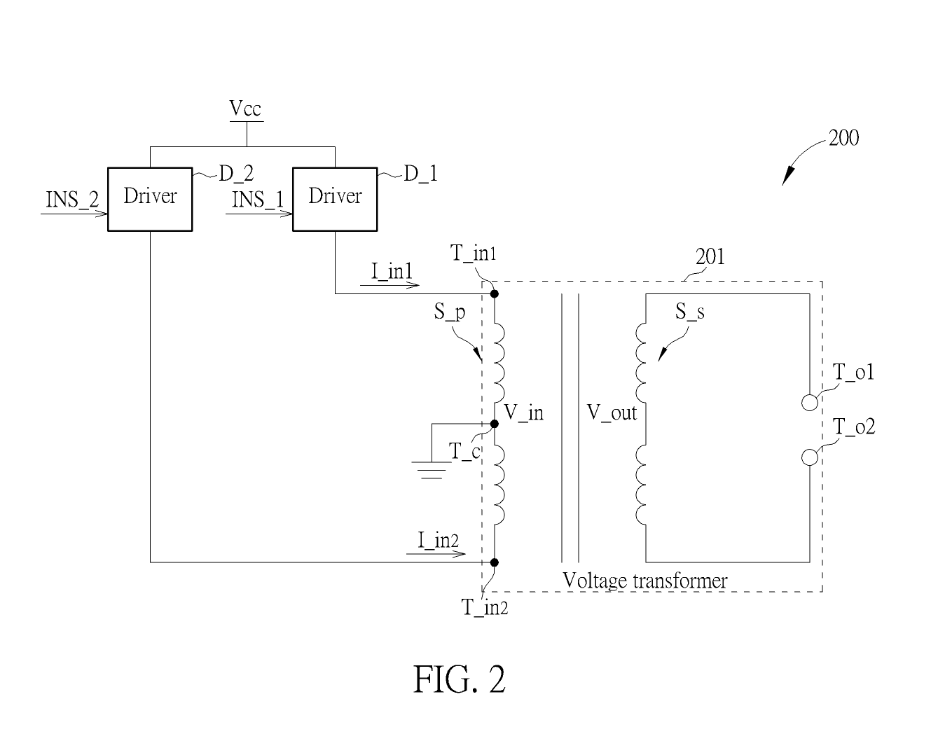

FIG. 2 is a circuit diagram illustrating driving module according to one embodiment of the present invention. As illustrated in FIG. 2, the driving module 200 comprises a transformer 201 and drivers D_1, D_2. The transformer 201 comprises a primary side S_p, and a secondary side S_s. Please note the drivers D_1, D_2 can be integrated to a single driver, or separated into more than two drivers. The primary side S_p comprises a first input terminal T_in1, a second input terminal T_in2, and a center terminal T_c. The center terminal T_c is coupled to a first predetermined voltage (in this embodiment, a ground voltage). The primary side S_p is center tapped at the center terminal T_c. Drivers D_1, D_2 are coupled to a second predetermined voltage (in this embodiment, a supply voltage Vcc higher than the ground voltage), configured to receive at least one input signal (in this embodiment, two input signals INS_1, INS_2), to provide a first input current I_in1 to the center terminal T_c, and to provide a second input current I_in2 to the center terminal T_c. The first input current I_in1 flows from the first input terminal T_in1 to the center terminal T_c, and the second input current I_in2 flows from the second input terminal T_in2 to the center terminal T_c. Also, please note the second predetermined voltage (Vcc in this embodiment) is higher than the first predetermined voltage (a ground voltage in this embodiment). The primary side S_p generates an input voltage V_in based on the first input current T_in1 and the second input current T_in2. The secondary side S_s generates an output voltage V_out based on the input voltage V_in. The values of the first input current I_in1 and the second input current I_in2 depend on the input signals INS_1, INS_2.

Comparing with the driving module of a related art, the noise of the driving module provided by the present application can be suppressed since the primary side S_p is not directly coupled to the supply voltage Vcc. Also, the reliability of drivers D_1, D_2 can be increased since the drivers D_1, D_2 in the structure depicted in FIG. 2 can apply a PMOS or a PFET to generate the first input current I_in1 and the second input current I_in2.

It will be appreciated that the secondary side S_s for the driving module provided by the present application is not limited to have a structure illustrated in FIG. 2. Also, the transformer 201 is not limited to be applied to drivers depicted in FIG. 2.

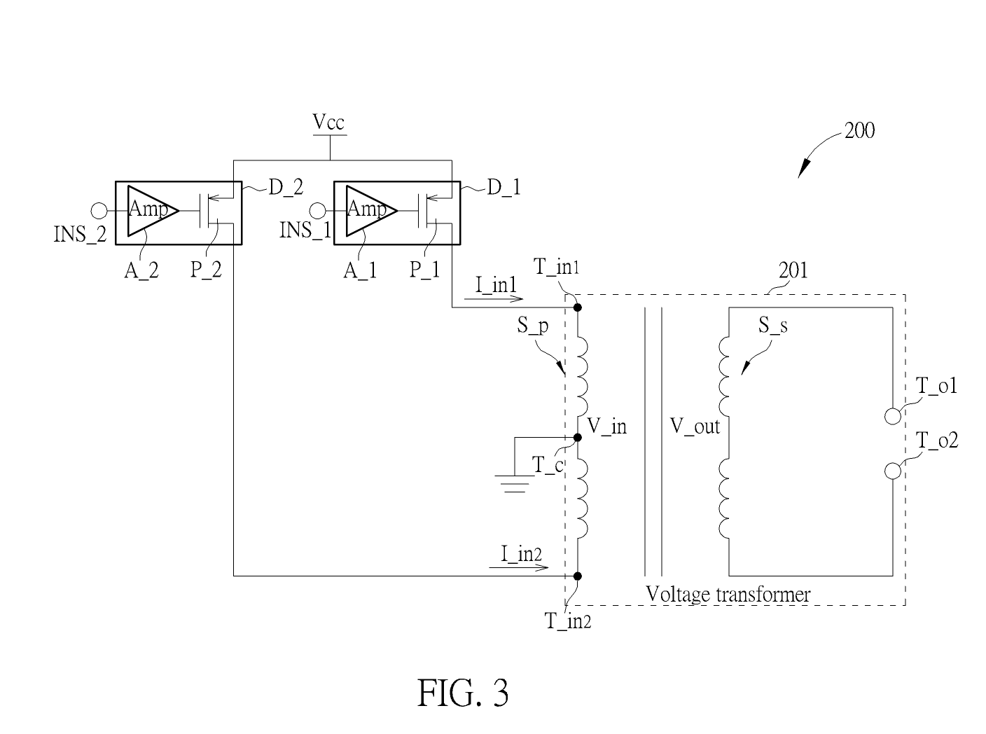

FIG. 3 is a circuit diagram illustrating an exemplary structure for the driving module depicted in FIG. 2. As illustrated in FIG. 3, the driver D_1 comprises an amplifier A_1 and a PMOS P_1, and the driver D_2 comprises an amplifier A_2 and a PMOS P_2. PMOS P_1 In such example, the amplifier A_1 receives the input signal INS_1 and amplifies the input signal INS_1 to control the PMOS P_1. Similarly, the amplifier A_2 receives the input signal INS_2 and amplifies the input signal INS_2 to control the PMOS P_2. It will be appreciated that the structure of the drivers D_1, D_2 are not limited to the structure depicted in FIG. 3. Please note the PMOS can be replaced with other kinds of P type transistors (ex. PFET).

Additionally, in one embodiment, the driving module provided by the present invention is applied to an electronic apparatus using Ethernet. Accordingly, the output terminals T_o1, T_o2 of the secondary side S_s are coupled to a cable, but not limited.

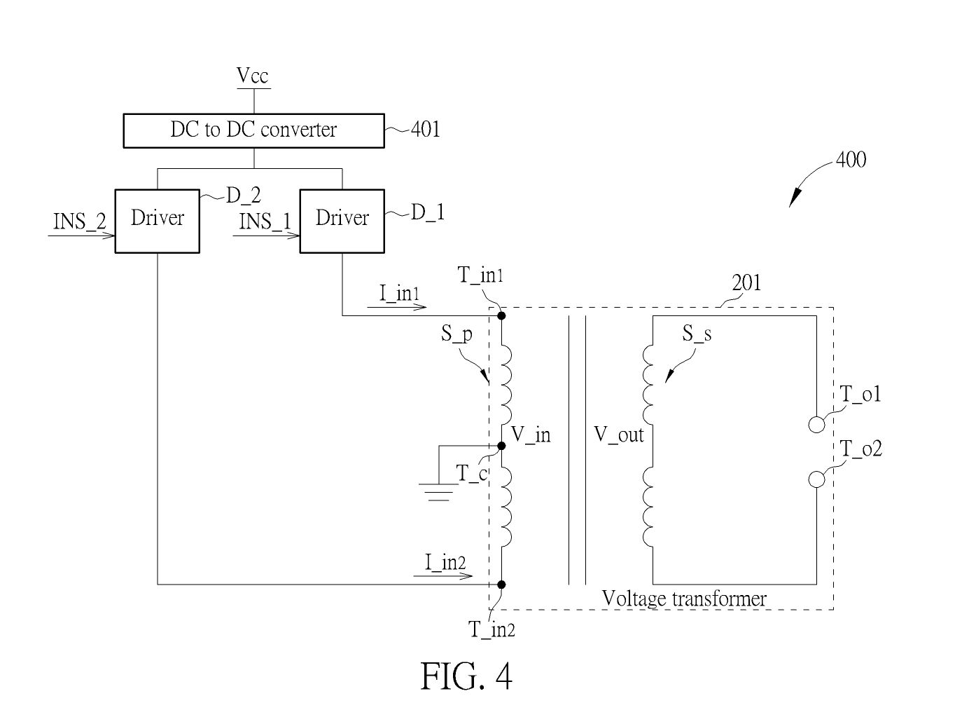

FIG. 4 is a circuit diagram illustrating a driving module 400 according to another embodiment of the present invention. Comparing with the embodiment depicted in FIG. 2, the driving module 400 in FIG. 4 further comprises a DC-to-DC converter 401 coupled between the second predetermined voltage (Vcc in this embodiment) and drivers D_1, D_2. The DC-to-DC converter 401 can provide different supply voltages depends on the required signal voltage amplitude (i.e. the output voltage V_out), such that “output voltage of DC-to-DC converter” is slightly larger than required voltage amplitude. That is, the DC-to-DC converter converting the supply voltage Vcc depending on a swing of the output voltage V_out.

In view of above-mentioned description, the output voltage of the DC-to-DC converter can be adjusted corresponding different standards (i.e. different output signal swings). Thereby the output voltage of the DC-to-DC converter can be minimized, such that the power consumption caused by the output voltage of the DC-to-DC converter can be minimized as well.

Additionally, the swing of the output voltage V_out can be controlled to meet different requirements. In one embodiment, the driving module provided by the present invention is applied to an electronic apparatus using Ethernet, and a swing of the output voltage V_out meets a 10G Base-T standard. Furthermore, in another embodiment, the driving module provided by the present invention is applied to an electronic apparatus using Ethernet, and a swing of the output voltage V_out meets a 1000 Base-T standard.

The DC to DC converter 401 can be replaced by other devices that can provide a function the same as which of the DC to DC converter 401. Therefore, the DC to DC converter can be regarded as a voltage converting circuit.

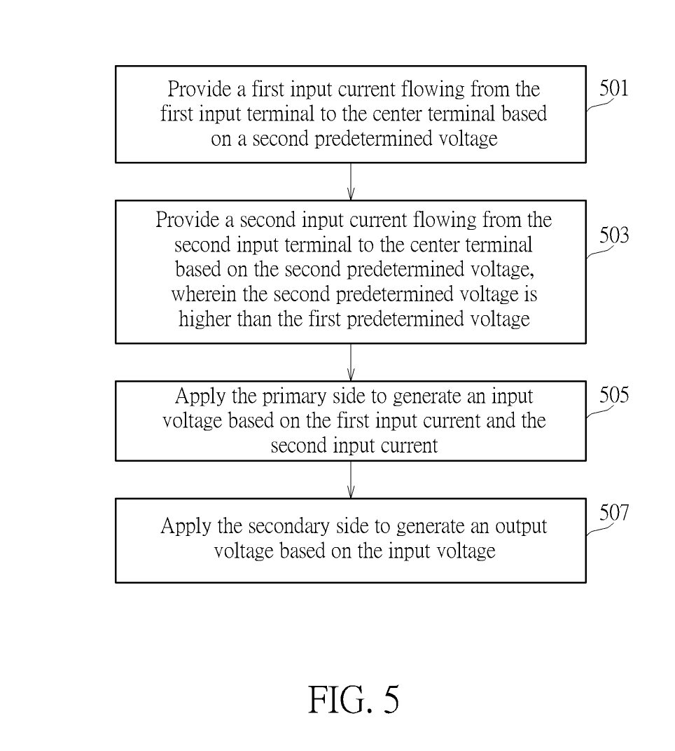

In view of above-mentioned embodiments, a driving method can be acquired, which is applied to a driving module comprising a transformer including a primary side (ex. S_p in FIG. 2) and a secondary side (ex. S_s in FIG. 2). The primary side comprises a first input terminal (ex. T_in1 in FIG. 2), a second input terminal (ex. T_in2 in FIG. 2), and a center terminal (ex. T_c in FIG. 2) coupled to a first predetermined voltage. The primary side is center tapped at the center terminal. The driving method comprises the steps illustrated in FIG. 5:

Step 501

Provide a first input current (ex. I_in1 in FIG. 2) flowing from the first input terminal to the center terminal based on a second predetermined voltage.

Step 503

Provide a second input current (ex. I_in2 in FIG. 2) flowing from the second input terminal to the center terminal based on the second predetermined voltage, wherein the second predetermined voltage is higher than the first predetermined voltage.

Step 505

Apply the primary side to generate an input voltage (ex. V_in in FIG. 2) based on the first input current and the second input current.

Step 507

Apply the secondary side to generate an output voltage (ex. V_out) based on the input voltage.

Other detail steps can be acquired based on above-mentioned embodiments, thus are omitted for brevity here.

In view of above-mentioned embodiments, the driving module and the driving method provided by the present application can reduce noise since the primary side is not coupled to a supply voltage, and can increase reliability since the driver can apply a PMOS or a PFET. Additionally, the driving module and the driving method provided by the present application can suppress power consumption since the operating voltage of the driver can be minimized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving module, comprising:
a transformer, comprising:
a primary side, comprising a first input terminal, a second input terminal, and a center terminal coupled to a first predetermined voltage, wherein the primary side is center tapped at the center terminal; and
a secondary side; and
at least one driver, coupled to a second predetermined voltage, configured to receive at least one input signal, to provide a first input current flowing from the first input terminal to the center terminal according to the input signal, and to provide a second input current flowing from the second input terminal to the center terminal according to the input signal;
wherein the primary side generates an input voltage based on the first input current and the second input current, wherein the secondary side generates an output voltage based on the input voltage;
wherein the second predetermined voltage is higher than the first predetermined voltage.

2. The driving module of claim 1, wherein the first predetermined voltage is a ground level.

3. The driving module of claim 1, wherein the driver comprises at least one P type transistor to provide the first input current and the second input current.

4. The driving module of claim 1, wherein the P type transistor is a PMOS or a PFET.

5. The driving module of claim 1, further comprising:
a voltage converting circuit, coupled between the second predetermined voltage and the driver, configured to convert the second predetermined voltage according to a swing of the output voltage.

6. The driving module of claim 4, wherein the voltage converting circuit is a DC to DC converter.

7. The driving module of claim 1, wherein a swing of the output voltage meets a 10G Base-T standard.

8. The driving module of claim 1, wherein a swing of the output voltage meets a 1000 Base-T standard.

9. A driving method, applied to a driving module comprising a transformer with a primary side and a secondary side, wherein the primary side comprises a first input terminal, a second input terminal, and a center terminal coupled to a first predetermined voltage, wherein the primary side is center tapped at the center terminal, wherein the driving method comprises:
providing a first input current flowing from the first input terminal to the center terminal based on a second predetermined voltage;
providing a second input current flowing from the second input terminal to the center terminal based on the second predetermined voltage, wherein the second predetermined voltage is higher than the first predetermined voltage;
applying the primary side to generate an input voltage based on the first input current and the second input current; and
applying the secondary side to generate an output voltage based on the input voltage.

10. The driving method of claim 9, wherein the first predetermined voltage is a ground level.

11. The driving method of claim 9, further comprising:
converting the second predetermined voltage according to a swing of the output voltage.

12. The driving method of claim 9, wherein a swing of the output voltage meets a 10G Base-T standard.

13. The driving method of claim 9, wherein a swing of the output voltage meets a 1000 Base-T standard.

14. A transformer, comprising:
a primary side, comprising a first input terminal configured to receive a first input current, a second input terminal configured to receive a second input current, and a center terminal coupled to a first predetermined voltage;
wherein the first input current and the second input current are generated according to a second predetermined voltage higher than the first predetermined voltage;
wherein the primary side is center tapped at the center terminal.

15. The transformer of claim 14, wherein the first predetermined voltage is a ground voltage.
